(19) United States
(12) Patent Application Publication
(10) Pub. No.: US 2025/0202152 A1
(43) Pub. Date: Jun. 19, 2025

(54) CONNECTOR ASSEMBLY

(71) Applicant: SUMITOMO WIRING SYSTEMS, LTD., Mie (JP)

(72) Inventor: Ikki SAGO, Mie (JP)

(21) Appl. No.: 18/978,519

(22) Filed: Dec. 12, 2024

(30) Foreign Application Priority Data
Dec. 18, 2023 (JP) 2023-213093

(51) Int. Cl. H01R 13/436; H01R 13/52

(52) U.S. Cl. CPC H01R 13/4367; H01R 13/5202

(57) ABSTRACT

A first housing includes a first tube part within which a seal ring provided in a second housing is to be fitted; temporary holding parts extending along a fitting direction from a front end portion of the first tube part in the fitting direction; and guide parts (first guide part and second guide part) extending further forward than the temporary holding parts in the fitting direction. The temporary holding parts are configured to temporarily hold the second housing using a frictional force with the seal ring in a state before the seal ring is fitted within the first tube part. The guide parts are configured to guide fitting of the first housing along the fitting direction by being inserted into insertion target parts of the second housing before the temporary holding parts come into contact with the seal ring.

### CROSS-REFERENCE TO RELATED APPLICATIONS

This application is based on and claims priority from Japanese Patent Application No. 2023-213093, filed on Dec. 18, 2023, with the Japan Patent Office, the disclosure of which is incorporated herein in its entirety by reference.

### TECHNICAL FIELD

The present disclosure relates to a connector assembly.

### BACKGROUND

Some conventional connector assemblies include a first connector configured to be fixed to a base member such as a vehicle body panel and a metal case, and a second connector that is connectable to the first connector (see e.g., JP 2019-110026A). The first connector includes a first housing, and a first terminal that is held by the first housing. The second housing is fixed to the base member using a bolt configured to be threadably engaged with an internal thread of the base member.

### SUMMARY

Improvement in operability during mounting the first connector and the second connector to each other is required for the connector assembly as described above. For example, for a configuration in which the first terminal and the second terminal are fitted to each other using the axial force generated when threadably engaging the bolt, the operator needs to threadably engage the bolt while supporting the second housing with his or her hand. In such a case, the connector assembly as described above has the problem of poor operability.

An object of the present disclosure is to provide a connector assembly that allows for improvement in operability during mounting.

A connector assembly according to the present disclosure is a connector assembly including: a first connector configured to be fixed to a base member; and a second connector that is connectable to the first connector, wherein the first connector includes a first housing, and a first terminal that is held by the first housing, the second connector includes a second housing that is fittable to the first housing, a second terminal that is held by the second housing, and an annular seal ring that is held by the second housing, the first housing is fitted to the second housing by being moved relative to the second housing toward the fitting direction, the first housing includes a tube part within which the seal ring is to be fitted, a temporary holding part extending toward the fitting direction from a front end portion of the tube part in the fitting direction, and at least one guide part extending further forward than the temporary holding part in the fitting direction, the temporary holding part is configured to temporarily hold the second housing using a frictional force with the seal ring in a state before the seal ring is fitted within the tube part; and the at least one guide part is configured to guide fitting of the first housing along the fitting direction by being inserted into an insertion target part of the second housing before the temporary holding part comes into contact with the seal ring.

The connector assembly according to the present disclosure allows for improvement in operability during mounting.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector assembly according to an embodiment.

FIG. 2 is an exploded perspective view of the connector assembly according to the embodiment.

FIG. 3 is an exploded side view of the connector assembly according to the embodiment.

FIG. 4 is a cross-sectional view of the connector assembly according to the embodiment.

FIG. 5 is a cross-sectional view taken along the line 5-5 in FIG. 4.

FIG. 6 is a cross-sectional view taken along the line 6-6 in FIG. 5.

FIG. 7 is a side view of the connector assembly in a pre-fitting state according to the embodiment.

FIG. 8 is a cross-sectional view of the connector assembly in the pre-fitting state according to the embodiment.

FIG. 9 is a partial perspective view partially showing a second housing with a seal ring attached thereto.

FIG. 10 is a cross-sectional view for illustrating the operations of the connector assembly according to the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF THE PRESENT DISCLOSURE

First, embodiments of the present disclosure will be listed and described.

[1] A connector assembly according to the present disclosure is a connector assembly including: a first connector configured to be fixed to a base member; and a second connector that is connectable to the first connector, wherein the first connector includes a first housing, and a first terminal that is held by the first housing, the second connector includes a second housing that is fittable to the first housing, a second terminal that is held by the second housing, and an annular seal ring that is held by the second housing, the first housing is fitted to the second housing by being moved relative to the second housing toward the fitting direction, the first housing includes a tube part within which the seal ring is to be fitted, a temporary holding part extending toward the fitting direction from a front end portion of the tube part in the fitting direction, and at least one guide part extending further forward than the temporary holding part in the fitting direction, the temporary holding part is configured to temporarily hold the second housing using a frictional force with the seal ring in a state before the seal ring is fitted within the tube part; and the at least one guide part is configured to guide fitting of the first housing along the fitting direction by being inserted into an insertion target part of the second housing before the temporary holding part comes into contact with the seal ring.

With this configuration, the temporary holding part of the first housing temporarily holds the second housing using a frictional force with the seal ring in a state before the seal ring is fitted within the tube part, thus resulting in a good operability during mounting. For example, when the first housing and the second housing are made of resin or metal, the components need to be manufactured with high accuracy in order to provide a structure that allows for temporary holding without using the seal ring. In contrast, this configuration uses the frictional force with the seal ring, which can absorb manufacturing errors, and therefore the components do no need to be manufactured with high accuracy. Furthermore, with the above-described configuration, the at least one guide part of the first housing guides fitting of the first housing to the second housing along the fitting direction before the temporary holding part comes into contact with the seal ring. Accordingly, for example, when the first housing is mounted to the second housing while being inclined relative to the fitting direction, it is possible to inhibit the seal ring from being turned up as a result of the front end portion of the temporary holding part in the fitting direction being caught on the seal ring.

[2] In [1] above, the first housing may include a pair of side walls extending along the fitting direction and opposed to each other, the first terminal may be provided between the two side walls, and each of the side walls may include, as a single piece therewith, the temporary holding part and the at least one guide part.

With this configuration, the temporary holding part and the at least one guide part are included in each of the side walls, thus making it possible to contribute to simplification of the configuration of the first housing.

[3] In [2] above, the first housing may include a terminal protection part extending along the first terminal at least in a portion of an area surrounding the first terminal in a circumferential direction, and, in the fitting direction, a front end portion of the temporary holding part may be located further forward than a front end portion of the terminal protection part.

With this configuration, the terminal protection part can be protected by the side walls each including the temporary holding part and the at least one guide part.

[4] In [2] or [3] above, when a first direction is a direction in which the two side walls are opposed to each other, and a second direction is a direction that is perpendicular to each of the fitting direction and the first direction, the at least one guide part may include a plurality of guide parts that are respectively provided at opposite end portions of each of the side walls in the second direction.

With this configuration, fitting of the first housing to the second housing along the fitting direction can be more reliably guided by the guide parts respectively provided at the opposite end portions of each of the side walls.

[5] In any one of [1] to [4] above, the connector assembly may further include a bolt, wherein the second housing may have a fixing hole extending therethrough along the fitting direction, and may be fixed to the base member using the bolt configured to pass through the fixing hole and be threadably engaged with an internal thread provided in the base member.

With this configuration, the second housing is fixed to the base member using the bolt configured to pass through the fixing hole and be threadably engaged with the internal thread. Thus, the second housing can be temporarily held by the first housing before threadably engaging the bolt, for example. Accordingly, the operator can perform the operation of threadably engaging the bolt with his or her hand released from the second housing, for example. This results in a good operability during a mounting operation.

### Details of Embodiments of the Present Disclosure

Specific examples of the connector assembly according to the present disclosure will be described below with reference to the drawings. In the drawings, portions of configurations may be shown exaggerated or simplified for convenience of description. Also, dimensional proportions of the portions may be different from the actual dimensional proportions in the drawings. The drawings show an X axis, a Y axis, and a Z axis that are orthogonal to each other. As used herein, a direction extending along the X axis is referred to as an X-axis direction, a direction extending along the Y axis is referred to as a Y-axis direction, and a direction extending along the Z axis is referred to as a Z-axis direction. Being “parallel”, “perpendicular” or “orthogonal” as used herein includes not only being exactly parallel, perpendicular, or orthogonal, but also being substantially parallel, perpendicular, or orthogonal, as long as the operations and effects of the present embodiment can be achieved. The term “tubular” as described herein includes not only a shape with a peripheral wall continuously formed around the entire circumference in a circumferential direction, but also a tubular shape formed by a combination of a plurality of components, and a tubular shape having a partially cut-out portion or the like in a circumferential direction thereof, such as a C-shape. Also, the “tubular” shape includes a circular shape, an elliptic shape, and a polygonal shape having a pointed or round angle. The term “annular” as used in the description of the present specification may refer to any structure that forms a loop, or a continuous shape having no end portion, and a generally loop-shaped structure having a gap such as a C-shape. Note that the “annular” shape includes, but is not limited to, a circular shape, an elliptic shape, and a polygonal shape having a pointed or round angle. The term “opposed” as used herein refers to that surfaces or members are located in front of each other, and includes not only a case where they are located fully in front of each other, but also a case where they are located partially in front of each other. In addition, “opposed” as used herein includes both a case where two portions are opposed with a portion other than the two portions interposed therebetween, and a case where two portions are opposed with nothing interposed therebetween. As used herein, the terms “first”, “second”, and the like are used to simply differentiate objects, and not to be construed as ranking objects. It should be noted that the present invention is not limited to these examples, and is intended to include all modifications which fall within the scope of the claims and the meaning and scope of equivalents thereof.

### (Connector Assembly 11)

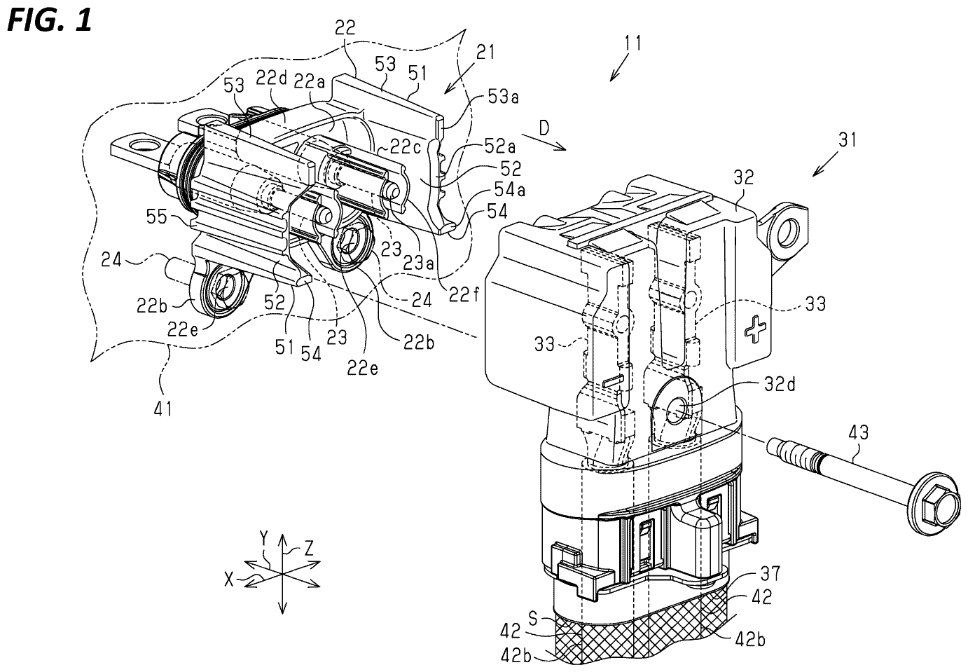

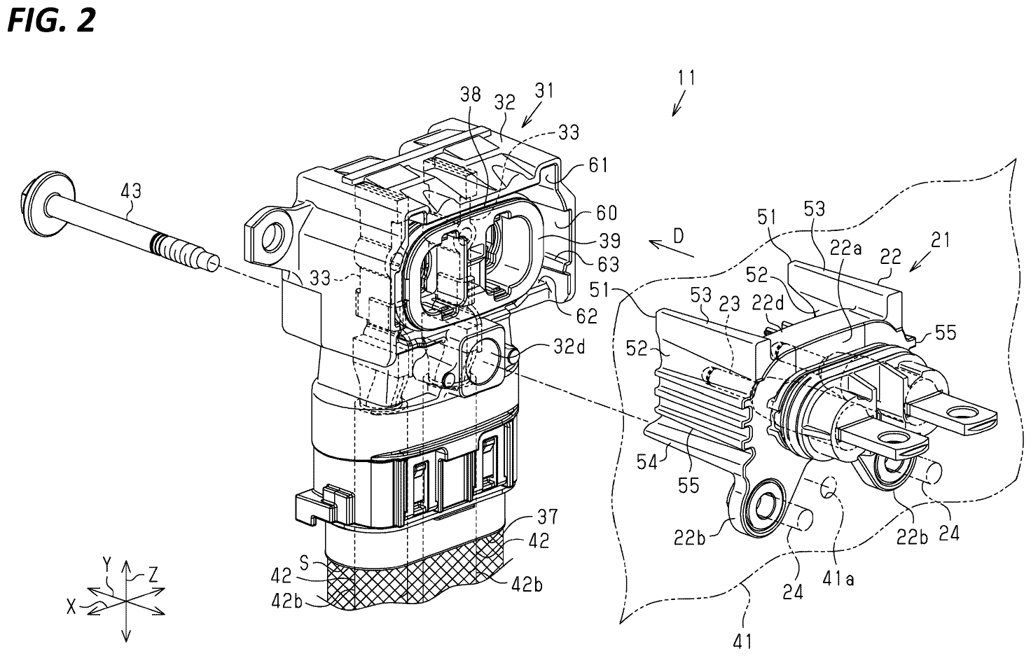

As shown in FIGS. 1 and 2, a connector assembly 11 includes a first connector 21, and a second connector 31 that is connectable to the first connector 21. The connector assembly 11 is provided in a vehicle. For example, the first connector 21 is fixed to a metal case 41 serving as a base member in the vehicle. For example, the second connector 31 is fixed to end portions of two wires 42.

### (First Connector 21)

As shown in FIG. 1, the first connector 21 includes a first housing 22, and, for example, two first terminals 23 that are held by the first housing 22. The first housing 22 is made of resin, for example. The first housing 22 is fitted to a second housing 32, which will be described below, constituting the second connector 31 by being moved relative to the second housing 32 along a fitting direction D extending along the Y axis. In the following description, the front side and the rear side in the fitting direction D may be simply referred to a “font side” and a “rear side”.

The first housing 22 includes a base part 22a, fixing parts 22b, terminal protection parts 22c, a first tube part 22d, and a pair of side walls 51.

The base part 22a of the first housing 22 is formed in a plate shape. The base part 22a has a quadrangular shape that is elongated in the width direction as viewed in the Y-axis direction, for example, and is formed in a shape whose corners are chamfered by arc shapes. For example, two first terminals 23 are held by the base part 22a so as to be arranged in the X-axis direction. The first terminals 23 extend linearly along the fitting direction D extending along the Y axis. A cap 23a made of, for example, resin or rubber, is fixed to a front end portion of each of the first terminals 23 in the fitting direction D.

A pair of fixing parts 22b of the first housing 22 extend from, for example, portions of an outer edge of the base part 22a. Each of the fixing parts 22b has a through hole 22e extending the fixing part 22b in the Y-axis direction. The first housing 22 is fixed to the metal case 41 using fixing bolts 24 configured to pass through the corresponding through holes 22e and be threadably engaged with internal threads (not shown) provided in the metal case 41.

On the base part 22a, each of the terminal protection parts 22c protrudes from an area surrounding the corresponding first terminal 23 in the fitting direction D. The terminal protection part 22c extends along the first terminal 23 in a portion of the area surrounding the first terminal 23 in the circumferential direction. The terminal protection part 22c of the present embodiment is provided so as to be slightly spaced apart from the first terminal 23 in the width direction and cover the first terminal 23.

### (First Tube Part 22d)

The first tube part 22d of the first housing 22 has a tubular shape centered about an axis extending parallel to the Y axis. The first tube part 22d extends from, for example, the entire circumference of the outer edge of the base part 22a along the fitting direction D.

### (Pair of Side Walls 51)

The pair of side walls 51 of the first housing 22 are formed as a single piece with the first tube part 22d. The two side walls 51 are provided on opposite sides of the first tube part 22d in the X-axis direction so as to be opposed to each other in the X-axis direction. The two side walls 51 have shapes that are symmetrical to each other, for example. The first terminals 23 and the terminal protection parts 22c are provided between the two side walls 51 in the X-axis direction.

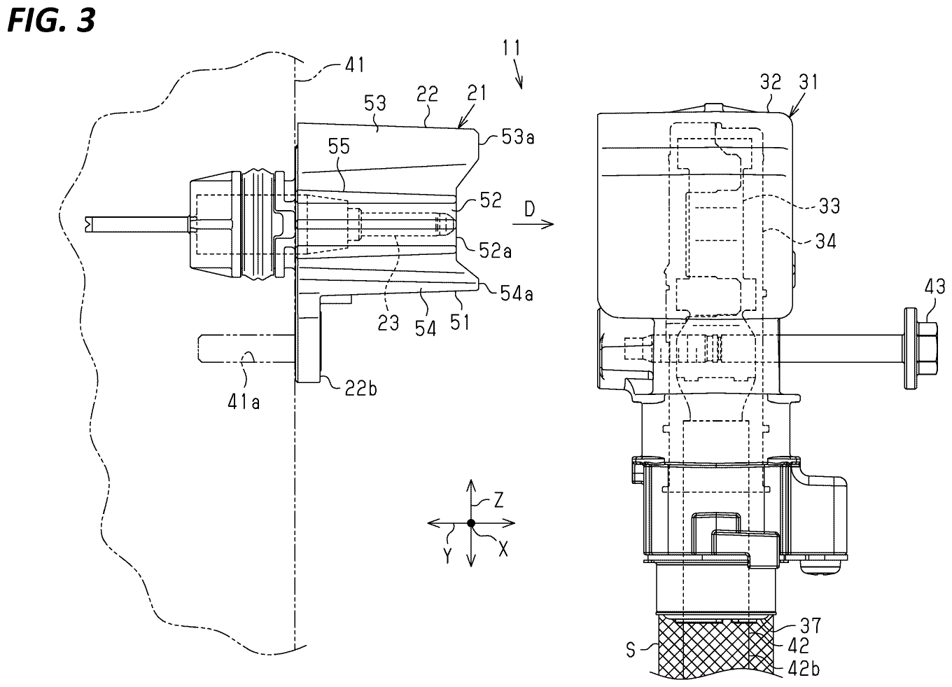

As shown in FIGS. 1, 2, and 3, each of the side walls 51 of the first housing 22 includes a temporary holding part 52, a first guide part 53, and a second guide part 54. The temporary holding part 52 extends along the fitting direction D from a front end portion of the first tube part 22d of the fitting direction D. The temporary holding part 52 extends from a portion of the front end portion of the first tube part 22d in the circumferential direction. The respective temporary holding parts 52 of the two side walls 51 are opposed to each other in the X-axis direction.

### (First Guide Part 53 and Second Guide Part 54)

The first guide part 53 of each of the side walls 51 of the first housing 22 is provided at one end portion of the corresponding temporary holding part 52 in the Z-axis direction. The second guide part 54 is provided at the other end portion of the corresponding temporary holding part 52 in the Z-axis direction (an end portion located opposite to the end portion in the Z-axis direction at which the first guide part 53 is provided). The first guide part 53 forms one end portion of the side wall 51 in the Z-axis direction, and the second guide part 54 forms the other end portion of the side wall 51 in the Z-axis direction. The first guide part 53 and the second guide part 54 have shapes that are different from each other. The first guide part 53 extends along the Z axis from one end portion of the temporary holding part 52 in the Z-axis direction, for example. The second guide part 54 has a shape whose width is longer than the width of the first guide part 53 in the X-axis direction.

Each of the first guide parts 53 and the second guide parts 54 extends further forward than the temporary holding parts 52 in the fitting direction D. That is, a front end portion 53a of each of the first guide parts 53 in the fitting direction D is located further forward than a front end portion 52a of the corresponding temporary holding part 52 in the fitting direction D. Also, a front end portion 54a of each of the second guide parts 54 in the fitting direction D is located further forward than the front end portion 52a of the corresponding temporary holding part 52 in the fitting direction D. Note that each of the first guide parts 53 and the second guide parts 54 has a tapered shape whose width in the X-axis direction is gradually narrowed toward the front side (the fitting direction D), for example.

In the fitting direction D, the front end portion 52a of the temporary holding part 52 of each of the side walls 51 is located further forward than a front end portion 22f of the corresponding terminal protection part 22c. That is, the first guide part 53 and the second guide part 54 of each of the side walls 51 are also located forward than the front end portion 22f of the corresponding terminal protection part 22c.

Each of the side walls 51 of the first housing 22 includes side ribs 55. On each of the side walls 51, the side ribs 55 protrude outward in the X-axis direction from an outer surface of the corresponding temporary holding part 52, and extend along the Y-axis direction. Also, on each of the side walls 51, a plurality of side ribs 55 are arranged in the Z-axis direction, for example.

### (Second Connector 31)

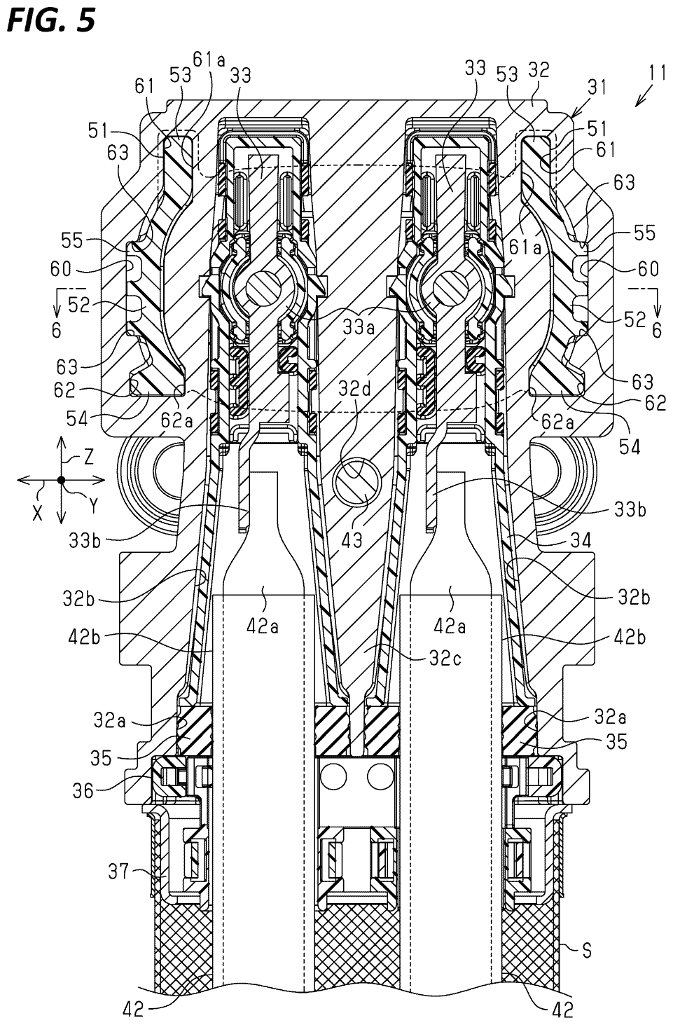

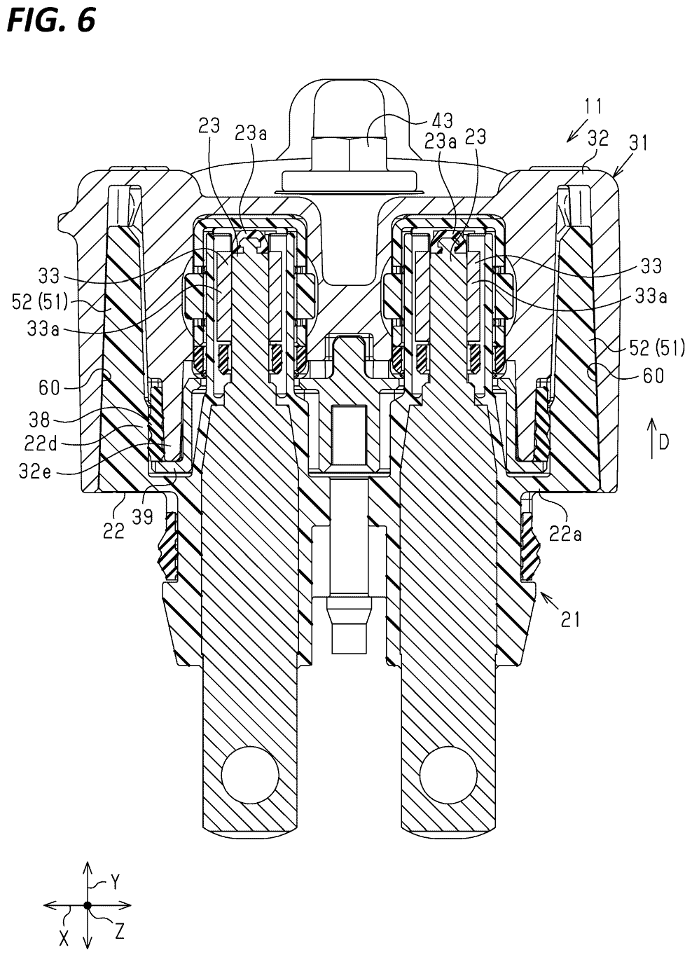

As shown in FIGS. 1 and 2, the second connector 31 includes a second housing 32 and second terminals 33. To the first housing 22 fixed to the metal case 41, the second housing 32 is mounted toward the Y-axis direction (more specifically, the direction opposite to the fitting direction D). The second terminals 33 are held by the second housing 32, and are fitted to the corresponding first terminals 23 in a housing fitting state (see FIGS. 5 and 6) in which the second housing 32 is fitted to the first housing 22.

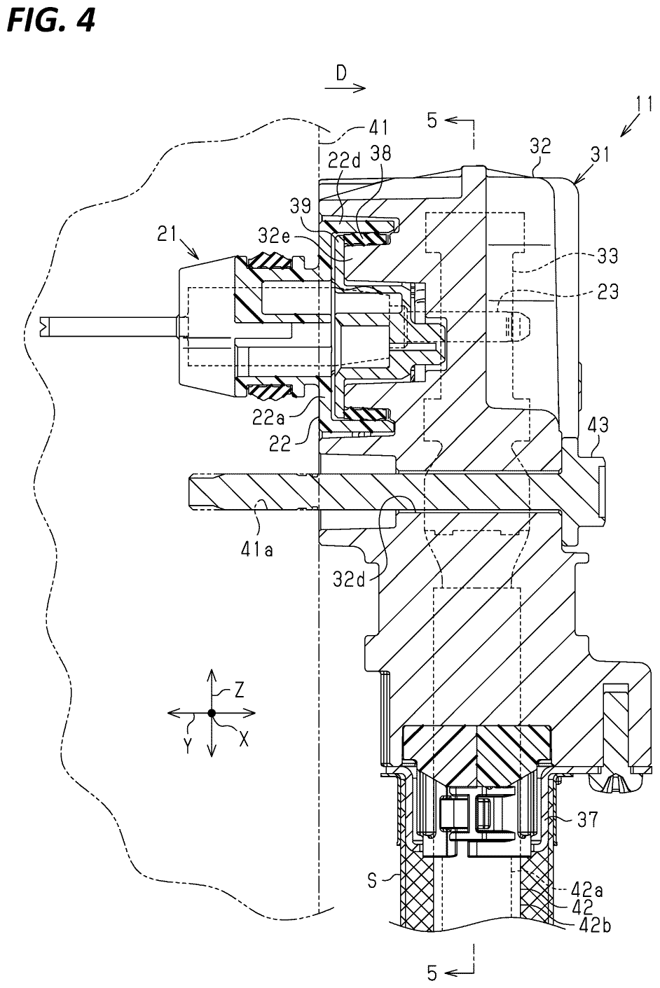

As shown in FIG. 5, the second connector 31 further includes resin housings 34, rubber stoppers 35, a retainer 36, and a metal bracket 37. As shown in FIGS. 4 and 6, the second connector 31 includes a seal ring 38. The seal ring 38 is made of rubber, for example.

The wires 42 each include a core wire 42a and an insulating coating 42b. The second terminals 33 are connected to end portions of the core wires 42a exposed from the insulating coatings 42b. The second terminals 33 extend along the Z-axis direction, and, in the present embodiment, two second terminals 33 are provided so as to correspond to the number of wires 42. The second terminals 33 each include a terminal fitting part 33a to which a first terminal 23 can be fitted, and a plate-shaped terminal connection part 33b configured to be connected to a core wire 42a. Although the second terminals 33 are each formed by bending a metal plate material, this is schematically shown in the drawing, without showing the details thereof. In the present embodiment, the terminal connection parts 33b and the corresponding core wires 42a are welded by resistance welding.

The resin housings 34 are each formed in a tubular shape so as to cover an exposed core wires 42a and a second terminal 33. Note that the resin housings 34 each have an opening for allowing passage of a first terminal 23 to be fitted to the corresponding terminal fitting part 33a.

The second housing 32 is made of metal, and is a metal shell having an electromagnetic shielding function. The second housing 32 is formed so as to cover the resin housings 34. The second housing 32 has openings 32a at a proximal end portion thereof in the Z-axis direction, and includes housing accommodating parts 32b extending toward a distal end in the Z-axis direction. The housing accommodating parts 32b are each formed according to the shape of the resin housings 34 so as to have a shape that can accommodate a resin housing 34 with substantially no gap. Two housing accommodating parts 32b are arranged side by side in the width direction so as to correspond to the number of resin housings 34.

Each of the rubber stoppers 35 is formed in a tubular shape, and is interposed between an insulating coating 42b and the corresponding opening 32a. Thus, the rubber stoppers 35 prevent entry of liquid into the second connectors 31 along the insulating coatings 42b.

The retainer 36 is made of resin. The retainer 36 is locked to the second housing 32, and prevents detachment of the rubber stoppers 35 from the openings 32a.

A collective shield member S serving as a shield member covering the insulating coatings 42b is connected to the metal bracket 37, and the metal bracket 37 is connected to the second housing 32. More specifically, the shield member of the present embodiment is a tubular collective shield member S that collectively covers a plurality of insulating coatings 42b. Also, the collective shield member S of the present embodiment is a braided member obtained by braiding conductive elemental wires of a copper alloy, an aluminum alloy, or the like into a tubular shape. The entire circumference of the collective shield member S is connected to the metal bracket 37, and the metal bracket 37 is connected to the second housing 32.

The second housing 32 includes a partition wall 32c between two housing accommodating parts 32b. The partition wall 32c is formed over the entire second housing 32 in the Z-axis direction. Also, the partition wall 32c is provided with a fixing hole 32d extending therethrough in the Y-axis direction. That is, the fixing hole 32d is provided between a plurality of wires 42 in the width direction in which the plurality of wires 42 are arranged side by side. In other words, the fixing hole 32d is provided at a position in the width direction between a position in the width direction at which one of the wires 42 is disposed, and a position in the width direction at which the other wire 42 is disposed. As shown in FIG. 4, the second housing 32 can be fixed to the metal case 41 using a bolt 43 configured to pass through the fixing hole 32d and be threadably engaged with an internal thread 41a provided in the metal case 41. The second housing 32 is fitted to the first housing 22 by being moved relative to the first housing 22 in the Y-axis direction using a force in the Y-axis direction that is generated when the bolt 43 is threadably engaged.

### (Second Tube Part 32e)

As shown in FIGS. 4 and 6, the second housing 32 includes a second tube part 32e configured to fit inside the first tube part 22d of the first housing 22 in the housing fitting state. The seal ring 38 is disposed on an outer circumferential surface of the second tube part 32e. The seal ring 38 has an annular shape as viewed from the Y-axis direction. The seal ring 38 is externally fitted to the second tube part 32e, and is prevented from being detached from the second tube part 32e by a front retainer 39 configured to be fitted in the second tube part 32e. The seal ring 38 waterproofs the space between the first housing 22 and the second housing 32 by being brought into close contact with an inner circumferential surface of the first tube part 22d in the housing fitting state.

### (Recess 60)

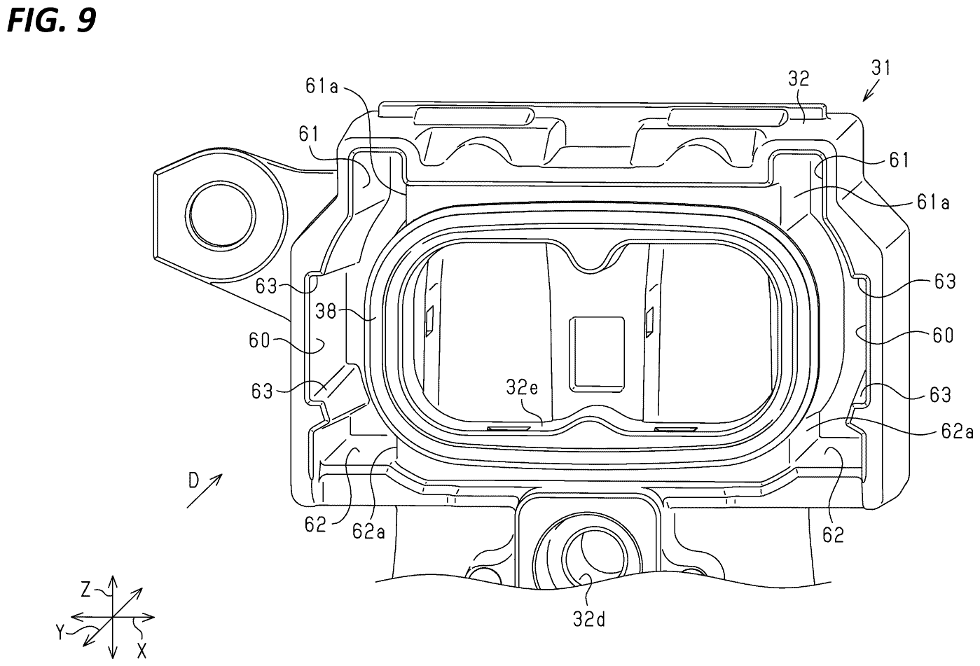

As shown in FIGS. 5 and 9, the second housing 32 includes a pair of recesses 60 into which the pair of side walls 51 of the first housing 22 enter. Each of the recesses 60 includes a first insertion target part 61 into which the first guide part 53 of the corresponding side wall 51 is to be inserted, and a second insertion target part 62 into which the second guide part 54 of the corresponding side wall 51 is to be inserted. The first guide part 53 and the second guide part 54 guide fitting of the first housing 22 to the second housing 32 along the fitting direction D by being inserted into the first insertion target part 61 and the second insertion target part 62, respectively.

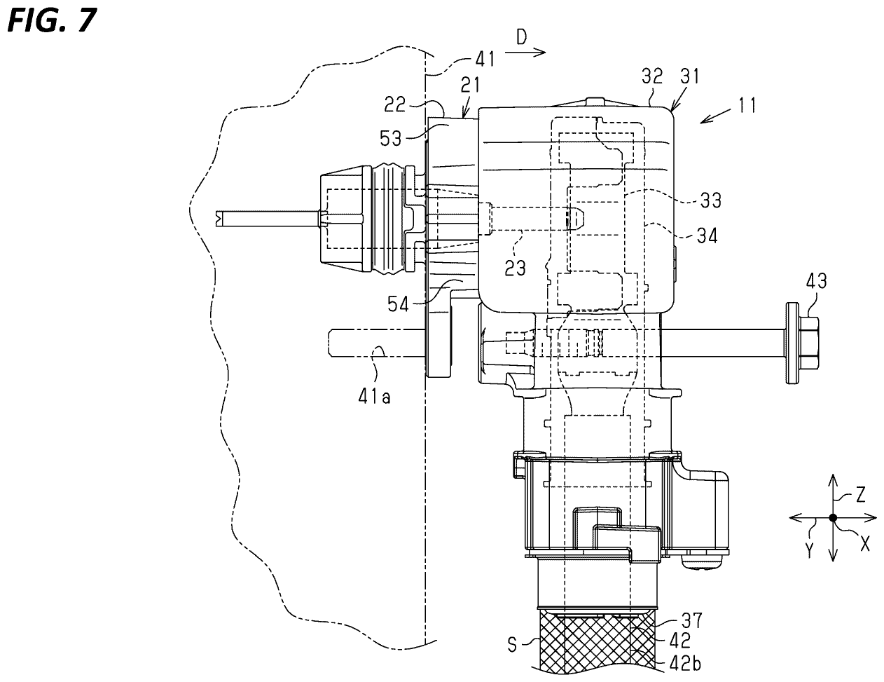

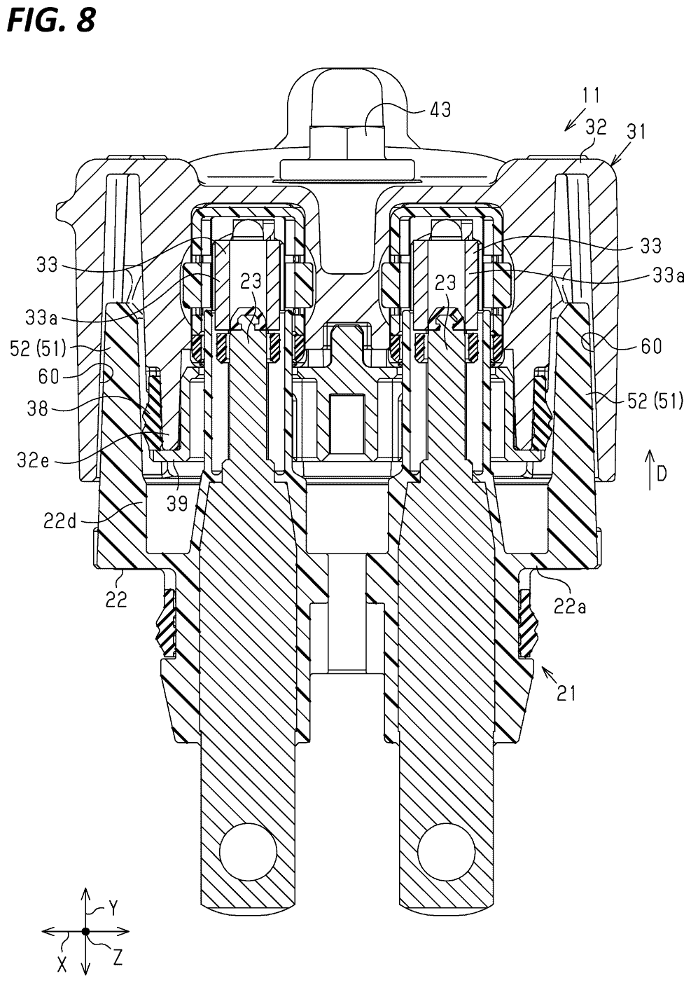

As shown in FIG. 5, each of the recesses 60 of the second housing 32 includes engaging parts 63 that are engageable with the corresponding side ribs 55 in the Z-axis direction. In each of the recesses 60, a pair of engaging parts 63 are provided so as to be respectively engageable with a pair of side ribs 55 disposed at opposite ends in the Z-axis direction among the side ribs 55 arranged in the Z-axis direction. The engaging parts 63 are engageable with the corresponding side ribs 55 in a pre-fitting state (see FIGS. 7 and 8) before entering the housing fitting state.

As shown in FIG. 8, the temporary holding parts 52 of the side walls 51 of the first housing 22 are set to be able to temporarily hold the second housing 32 using the frictional force with the seal ring 38 in the pre-fitting state before entering the housing fitting state. Note that the frictional force with the seal ring 38 refers to the resistance force against the relative movement between the seal ring 38 and the temporary holding parts 52 in contact with the seal ring 38. The temporary holding part 52 temporarily holds the second housing 32 as a result of the seal ring 38 being brought into contact with the inner circumferential surface thereof in the pre-fitting state. Note that temporary holding as used herein refers to holding to such an extent that, for example, when the Y-axis direction is the horizontal direction as shown in FIG. 7, the second housing 32 will not be detached from the first housing 22 even if the operator releases his or her hand from the second housing 32 in the pre-fitting state.

Also, the temporary holding parts 52 are set to come into contact with the seal ring 38 at a surface pressure that is lower than a surface pressure at which the first tube part 22d comes into close contact with the seal ring 38 (see FIG. 6). That is, the interval between the inner circumferential surfaces of the temporary holding parts 52 that are opposed each other is set to be larger than the interval between the inner circumferential surfaces of the first tube part 22d that are opposed to each other in the same direction. In other words, the temporary holding parts 52 and the first tube part 22d are formed so as to collapse the seal ring 38 more significantly in the housing fitting state (see FIG. 6) than in the pre-fitting state (see FIG. 8).

In the present embodiment, the first terminal 23 and the second terminal 33 are set to be fitted to each other using a large force along the Y-axis direction that is generated when the bolt 43 is threadably engaged. That is, the first terminal 23 and the second terminal 33 are sized to make it difficult to fit the first terminal 23 and the second terminal 33 to each other simply by the operator gripping the second housing 32 and pushing in the second housing 32 in the Y-axis direction. Such a setting will reduce the contact resistance between the first terminal 23 and the second terminal 33.

### (Operations of the Present Embodiment)

The operations of the connector assembly 11 configured as described above will be described.

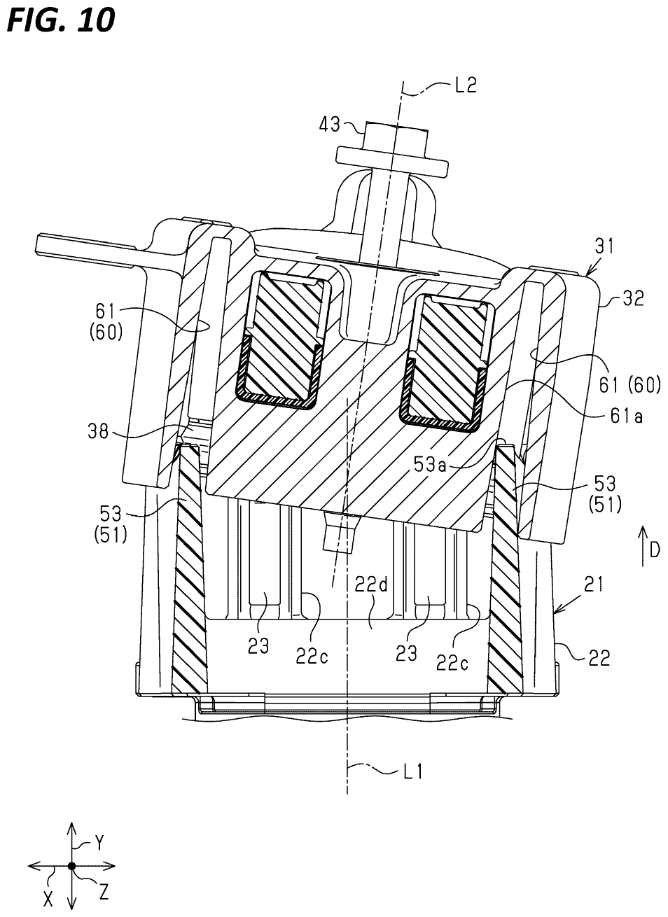

When mounting the first connector 21 and the second connector 31 to each other, the operator grips the second housing 32 and mounts the second housing 32 to the first housing 22 toward the Y-axis direction (more specifically, the direction opposite to the fitting direction D). At this time, on the side walls 51 of the first housing 22, first, the first guide parts 53 and the second guide parts 54 are inserted into the first insertion target parts 61 and the second insertion target parts 62, respectively, of the recesses 60. Here, for example, as shown in FIG. 10, the second housing 32 may be mounted in a state in which an axis L2 of the second connector 31 is inclined relative to an axis L1 of the first connector 21. In this case, the front end portion 53a of the first guide part 53 of one of the side walls 51 comes into contact with an inner side surface 61a of the corresponding first insertion target part 61. Also, the front end portion 54a of the second guide part 54 of the side wall 51 comes into contact with an inner side surface 62a of the corresponding second insertion target part 62 (see FIG. 9). In this manner, the first guide part 53 and the second guide part 54 come into contact with the inner side surface 61a of the first insertion target part 61 and the inner side surface 62a of the second insertion target part 62, respectively. Thus, the second housing 32 is guided such that the inclination angle of the axis L2 of the second connector 31 relative to the axis L1 of the first connector 21 decreases. Thereafter, in a state in which the inclination angle of the axis L2 of the second connector 31 relative to the axis L1 of the first connector 21 has decreased, the front end portions 52a of the temporary holding parts 52 of the side walls 51 are brought into contact with the seal ring 38 by being guided by the first guide parts 53 and the second guide parts 54.

Here, as a comparative configuration, let us consider a case where the first guide parts 53 and the second guide parts 54 have been omitted from the first housing 22 of the above-described embodiment. In this comparative configuration, when the second housing 32 is mounted at an inclination angle of the axis L2 as shown in FIG. 10, the front end portions 52a of the temporary holding parts 52 will come into contact with the seal ring 38 at the same inclination angle. Then, the front end portions 52a of the temporary holding parts 52 may turn up the seal ring 38.

In that respect, according to the present embodiment, the inclination angle of the axis L2 when the front end portions 52a of the temporary holding parts 52 come into contact with the seal ring 38 is reduced by the first guide parts 53 and the second guide parts 54. This makes it possible to suppress the occurrence of an event in which the temporary holding parts 52 turn up the seal ring 38.

After the front end portions 52a of the temporary holding parts 52 of the side walls 51 have come into contact with the seal ring 38, the second housing 32 is pushed in along the Y-axis direction, thus bringing about the pre-fitting state before entering the housing fitting state.

In the pre-fitting state, the second housing 32 is temporarily held relative to the first housing 22 by the frictional force between the seal ring 38 and the temporary holding parts 52 of the side walls 51. That is, in the pre-fitting state, the second housing 32 will not be detached from the first housing 22 even if the operator releases his or her hand from the second housing 32. Then, for example, using a tool, the operator threadably engages the bolt 43 that has passed through the fixing hole 32d with the internal thread 41a of the metal case 41.

Then, with a large force along the Y-axis direction that is generated when the bolt 43 is threadably engaged, the second housing 32 and the first housing 22 are fitted to each other, and the second terminals 33 and the first terminals 23 are fitted to each other. At this time, the seal ring 38 is brought into close contact with the outer circumferential surface of the second tube part 32e and the inner circumferential surface of the first tube part 22d, whereby the space between the first housing 22 and the second housing 32 is waterproofed.

The collective shield member S is electrically connected to the metal case 41 via the metal bracket 37, the second housing 32, and the bolt 43, and is grounded. This favorably suppresses the electromagnetic noise radiation from the wires 42 and the second terminals 33 covered by the collective shield member S, the metal bracket 37, and the second housing 32.

### (Effects of the Present Embodiment)

The effects of the present embodiment will be described below.

(1) The temporary holding parts 52 of the first housing 22 temporarily hold the second housing 32 using the frictional force with the seal ring 38 in a state before the seal ring 38 is fitted to the first tube part 22d (pre-fitting state). This results in a good operability during mounting. For example, when the first housing 22 and the second housing 32 are made of resin or metal, the components need to be manufactured with high accuracy in order to provide a structure that allows for temporary holding without using the seal ring 38. In contrast, this configuration uses the frictional force with the seal ring 38, which can absorb manufacturing errors, and therefore the components do no need to be manufactured with high accuracy. Furthermore, according to the present embodiment, the first guide parts 53 and the second guide parts 54 of the first housing 22 are inserted into the first insertion target parts 61 and the second insertion target parts 62 of the second housing 32, respectively, before the temporary holding parts 52 come into contact with the seal ring 38. Thus, the first guide parts 53 and the second guide parts 54 guide fitting of the first housing 22 to the second housing 32 along the fitting direction D. Accordingly, when the first housing 22 is mounted to the second housing 32 while being inclined relative to the fitting direction D, it is possible to inhibit the seal ring 38 from being turned up as a result of the front end portions 52a of the temporary holding parts 52 in the fitting direction D being caught on the seal ring 38.

(2) The first housing 22 includes a pair of side walls 51 extending along the fitting direction D and opposed to each other. The first terminals 23 are provided between the two side walls 51. Also, each of the side walls 51 includes, as a single piece therewith, the temporary holding part 52, the first guide part 53, and the second guide part 54. With this configuration, the temporary holding part 52, the first guide part 53, and the second guide part 54 are included in each of the side walls 51, thus making it possible to contribute to simplification of the configuration of the first housing 22.

(3) The first housing 22 includes terminal protection parts 22c extending along the corresponding first terminals 23 in a portion of an area surrounding the first terminal 23 in the circumferential direction. Also, in the fitting direction D, the front end portions 52a of the temporary holding parts 52 are located further forward than the front end portions 22f of the terminal protection parts 22c. With this configuration, the terminal protection parts 22c can be protected by the side walls 51 including the temporary holding parts 52, the first guide parts 53, and the second guide parts 54.

(4) A first direction is a direction (X-axis direction) in which the two side walls 51 are opposed to each other, and a second direction is a direction (Z-axis direction) that is perpendicular to each of the direction fitting direction D and the first direction. Each of the first guide parts 53 and each of the second guide parts 54 are respectively provided at opposite end portions of the corresponding side wall 51 in the second direction. With this configuration, fitting of the first housing 22 to the second housing 32 along the fitting direction D can be more reliably guided by the first guide part 53 and the second guide part 54 respectively provided at the opposite end portions of each of the side walls 51.

(5) The second housing 32 is fixed to the metal case 41 using the bolt 43 configured to pass through the fixing hole 32d and be threadably engaged with the internal thread 41a. Thus, the second housing 32 can be temporarily held by the first housing 22 before threadably engaging the bolt 43, for example. Accordingly, the operator can perform the operation of, for example, threadably engaging the bolt 43 with his or her hand released from the second housing 32. This results in a good operability during a mounting operation.

(6) Since the temporary holding parts 52 are set so as to come into contact with the seal ring 38 at a surface pressure that is higher than a surface pressure at which the first tube part 22d come into close contact with the seal ring 38, it is possible to inhibit the second tube part 32e from being turned up from the seal ring 38 when being brought into the pre-fitting state. In the housing fitting state, the first tube part 22d comes into contact with the seal ring 38 at a high surface pressure, thus providing good waterproofing performance.

(7) The side walls 51 including the temporary holding parts 52, the first guide parts 53, and the second guide parts 54 are provided at positions corresponding to opposite end portions of the first tube part 22d in the X-axis direction. Accordingly, in the housing fitting state, the temporary holding parts 52, the first guide parts 53, and the second guide parts 54 can be arranged so as to avoid the second terminals 33 extending along the Z-axis direction. That is, for example, when the temporary holding parts 52 protrude from the entire circumferent of the first tube part 22d, the second housing 32 needs to be elongated in the Y-axis direction in order to prevent contact with the second terminals 33 in the housing fitting state. However, this can be avoided. Accordingly, it is possible to reduce the size of the connector assembly 11 along the Y-axis direction.

(8) The temporary holding parts 52 each include side ribs 55 protruding outward in the X-axis direction and extending in the Y-axis direction. Also, the second housing 32 includes engaging parts 63 that are engageable with the side ribs 55 in the Z-axis direction in the pre-fitting state. Thus, the second housing 32 is prevented from rotating in the pre-fitting state. That is, in the pre-fitting state, the second housing 32 can be prevented from being rotated relative to the first housing 22 about the axial center along the Y-axis direction. Note that this engagement has an auxiliary function when the first housing 22 temporarily holds the second housing 32.

### OTHER EMBODIMENTS

The above embodiment can be implemented with the following modifications.

The above embodiment and the following modifications can be implemented in combination with each other as long as there are no technical discrepancies.

In the first housing 22 of the above embodiment, only one of the first guide part 53 and the second guide part 54 may be provided as the guide part on each of the side walls 51. In correspondence therewith, only one of the first insertion target part 61 and the second insertion target part 62 may be provided as the insertion target part on each of the recesses 60 of the second housing 32.

In the first housing 22 of the above embodiment, the positions of the front end portions 52a of the temporary holding parts 52 in the fitting direction D may be set in the same manner as the positions of the front end portions 22f of the terminal protection parts 22c in the fitting direction D. Also, the front end portions 52a of the temporary holding parts 52 may be set to be further rearward than the front end portions 22f of the terminal protection parts 22c in the fitting direction D. With such a configuration, it is possible to further suppress the occurrence of an event in which the temporary holding parts 52 turn up the seal ring 38.

In the first housing 22 of the above embodiment, the temporary holding part 52, the first guide part 53, and the second guide part 54 are included as a single piece in one side wall 51. However, the present disclosure is not particularly limited thereto. For example, at least one of the first guide part 53 and the second guide part 54 may be configured to be separated from the temporary holding part 52.

The configuration, such as shapes, of the first guide parts 53 and the second guide parts 54 in the first housing 22 is not limited to those of the above embodiment, and can be changed as appropriate according to the configuration.

In the above embodiment, the second housing 32 is configured to be fixed to the metal case 41 using the bolt 43 configured to pass through the fixing hole 32d and be threadably engaged with the internal thread 41a. However, the present disclosure is not limited thereto, and the second housing 32 may be configured to be fixed to the metal case 41 using another structure. A second housing 32 configured to be fixed to the metal case 41 using another structure also allows the second housing 32 to be temporarily held, thus resulting in a good operability during a mounting operation.

In the above embodiment, the temporary holding parts 52 are set to come into contact with the seal ring 38 at a surface pressure that is lower than the surface pressure at which the first tube part 22d comes into contact with the seal ring 38. However, the present disclosure is not limited thereto, and the temporary holding parts 52 may come into contact with the seal ring 38 at the same surface pressure as the first tube part 22d. The temporary holding parts 52 may come into contact with the seal ring 38 at a surface pressure that is higher than the surface pressure at which the first tube part 22d comes into contact with the seal ring 38.

In the above embodiment, the temporary holding parts 52 protrude in the Y-axis direction from opposite sides of the first tube part 22d in the width direction. However, the present disclosure is not limited thereto, and the temporary holding parts 52 may protrude from, for example, the entire circumference of the first tube part 22d. In this case, it is possible to use, for example, a second connector 31 including second terminals 33 extending in the Y-axis direction. For example, with a second connector 31 including second terminals 33 extending in the Y-axis direction, the temporary holding parts 52 can be prevent from coming into contact with the second terminal 33 even when the temporary holding parts 52 protrude from the entire circumference of the first tube part 22d. Accordingly, it is possible to prevent an increase in size of the connector assembly 11 along the Y-axis direction. With a second connector 31 including second terminals 33 extending in the Y-axis direction, it is also possible to form each of the terminal protection parts 22c of the first housing 22 in the shape of a tube surrounding the entire periphery of the first terminal 23.

In the above embodiment, the side walls 51 of the first housing 22 include side ribs 55, and the recesses 60 of the second housing 32 include engaging parts 63 that are engageable with the corresponding side ribs 55 in the pre-fitting state. However, the present disclosure is not limited thereto, and the side walls 51 and the recesses 60 need not include the side ribs 55 and the engaging parts 63, respectively.

In the above embodiment, the second housing 32 is a metal shell. However, the present disclosure is not limited thereto, and the second housing 32 may be made of resin. The second connector 31 need not have an electromagnetic shielding function. In such a case, the insulating coatings 42b need not be covered by the collective shield member S.

In the above embodiment, the fixing hole 32d is provided between the plurality of wires 42 in the width direction. However, the present disclosure is not limited thereto, and the fixing hole 32d may be provided at a different position. For example, the fixing hole 32d may be provided in a fixing part that protrudes outward of the second housing 32 in the Z-axis direction and the width direction.

In the above embodiment, the second connectors 31 are configured to be fixed to end portions of two wires 42. However, the present disclosure is not limited thereto, and the second connectors 31 may be configured to be fixed to end portions of three or more wires, for example. In this case, the numbers of first terminals 23, second terminals 33, resin housings 34, and rubber stoppers 35 need to be changed according to the number of wires 42.

In the above embodiment, the base member is used as the metal case 41. However, the present disclosure is not limited thereto, and the metal case 41 may be changed to another base member. For example, the metal case 41 may be another base member such as a vehicle panel.

The embodiments disclosed herein are to be construed in all respects as illustrative, and the present invention is not limited thereto. That is, the scope of the present invention is defined by the claims and is intended to include all modifications which fall within the scope of the claims and the meaning and scope of equivalents thereof.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector assembly comprising:
a first connector configured to be fixed to a base member; and
a second connector that is connectable to the first connector, wherein
the first connector includes a first housing, and a first terminal that is held by the first housing,
the second connector includes a second housing that is fittable to the first housing, a second terminal that is held by the second housing, and an annular seal ring that is held by the second housing,
the first housing is fitted to the second housing by being moved relative to the second housing toward the fitting direction,
the first housing includes a tube part within which the seal ring is to be fitted, a temporary holding part extending toward the fitting direction from a front end portion of the tube part in the fitting direction, and at least one guide part extending further forward than the temporary holding part in the fitting direction,
the temporary holding part is configured to temporarily hold the second housing using a frictional force with the seal ring in a state before the seal ring is fitted within the tube part; and
the at least one guide part is configured to guide fitting of the first housing along the fitting direction by being inserted into an insertion target part of the second housing before the temporary holding part comes into contact with the seal ring.

2. The connector assembly according to claim 1, wherein
the first housing includes a pair of side walls extending along the fitting direction and opposed to each other,
the first terminal is provided between the two side walls, and
each of the side walls includes, as a single piece therewith, the temporary holding part and the at least one guide part.

3. The connector assembly according to claim 2, wherein
the first housing includes a terminal protection part extending along the first terminal at least in a portion of an area surrounding the first terminal in a circumferential direction, and,
in the fitting direction, a front end portion of the temporary holding part is located further forward than a front end portion of the terminal protection part.

4. The connector assembly according to claim 2, wherein,
when a first direction is a direction in which the two side walls are opposed to each other, and a second direction is a direction that is perpendicular to each of the fitting direction and the first direction,
the at least one guide part includes a plurality of guide parts that are respectively provided at opposite end portions of each of the side walls in the second direction.

5. The connector assembly according to claim 1,
further comprising a bolt, wherein
the second housing has a fixing hole extending therethrough along the fitting direction, and is fixed to the base member using the bolt configured to pass through the fixing hole and be threadably engaged with an internal thread provided in the base member.
